(19) United States
(12) Patent Application Publication
(10) Pub. No.: US 2018/0054803 A1
(43) Pub. Date: Feb. 22, 2018

(54) BASE STATION APPARATUS AND TERMINAL APPARATUS

(71) Applicant: SHARP KABUSHIKI KAISHA, Sakai City, Osaka (JP)

(72) Inventors: TOMOKI YOSHIMURA, Sakai City (JP); HIROMICHI TOMEBA, Sakai City (JP)

(73) Assignee: Sharp Kabushiki Kaisha, Sakai City, Osaka (JP)

(21) Appl. No.: 15/555,184

(22) PCT Filed: Feb. 29, 2016
(86) PCT No.: PCT/JP2016/056022

§ 371 Date: Sep. 1, 2017

(30) Foreign Application Priority Data
Mar. 2, 2015 (JP) 2015-040590

(51) Int. Cl. H04W 72/04

(52) U.S. Cl. CPC H04W 72/04; H04W 84/12

(57) ABSTRACT

In a transmission system in which data addressed to multiple terminal apparatuses is multiplexed, a preferable transmission frame that efficiently uses radio resources and that enables a transmission time of the frame to be reduced is constructed. A base station apparatus uses at least one of multiple radio resources to transmit a transmission frame to a terminal apparatus. The base station apparatus includes a physical-layer frame generating unit that divides the transmission frame addressed to the terminal apparatus into multiple transmission frames and that generates physical layer frames so that the transmission frames obtained through division are transmitted in multiple radio resources, and also includes a radio transmission unit that transmits the generated physical layer frames to the terminal apparatus in the multiple radio resources.

### TECHNICAL FIELD

The present invention relates to a technique of transmitting a transmission frame to a terminal apparatus by using at least one of multiple radio resources.

### BACKGROUND ART

IEEE (The Institute of Electrical and Electronics Engineers Inc.) has defined IEEE 802.11ac that achieves a further increase in the speed of IEEE 802.11 that is a wifeless LAN (Local Area Network) standard. Currently, as a succeeding standard of IEEE 802.11ac, activities for standardizing IEEE 802.11ax (hereinafter also referred to as “802.11ax”) have started. Also in the standardization of 802.11ax, a study for improving throughput per user in an environment in which wireless LAN devices are located overcrowded has progressed with rapid, widespread use of wireless LAN devices.

A wireless LAN system is a system that makes a determination about whether transmission is to be performed, on the basis of carrier sense (CS: Carrier Sense). When a reception interference level obtained through carrier sense is lower than a threshold, the wireless LAN system determines that it is possible to perform transmission. When interference power higher than the threshold is received, transmission is avoided.

In the standardization of IEEE 802.11ax, introduction of DL-OFDMA in which a frequency band is divided so that the frequency bands obtained through division are allocated to multiple wireless LAN devices for transmission has been studied. In DL-OFDMA, data addressed to multiple terminal apparatuses may be transmitted in a multiplex manner. Therefore, compared with OFDM of the related art, effects of reduction in transmission waiting time and header, and the like are expected. In the standardization of IEEE 802.11ax an environment in which wireless LAN devices are located overcrowdedly is assumed. Therefore, it is expected that an effect of multiplex access using DL-OFDMA is conspicuous.

In application of DL-OFDMA to wireless LAN systems, the configuration of a transmission frame has been an issue. Data addressed to a terminal apparatus may be different in size from data addressed to another terminal apparatus. A transmission frame in DL-OFDMA has to be constructed in accordance with data of the maximum size. Therefore, the sizes, which are other than the maximum size, of pieces of data addressed to terminal apparatuses need to match the size, which is the maximum, of data addressed to a terminal apparatus.

### CITATION LIST

### Patent Literature

PTL 1: Japanese Unexamined Patent Application Publication No. 2014-212579

### Non Patent Literature

NPL 1: IEEE 802.11-14/1209r1 Multiple RF Operation for 802.11ax OFDMA

### SUMMARY OF INVENTION

### Technical Problem

In NPL 1, a method of constructing a transmission frame in DL-OFDMA has been proposed. In the proposed method, padding is performed on pieces of data that have sizes other than the maximum size and that are addressed to terminal apparatuses. Padding causes the sizes of pieces of data addressed to the terminal apparatuses to be apparently equal to one another. Therefore, DL-OFDMA transmission frames may be constructed. However, the method described in NPL 1 causes redundant areas produced through padding to be set, resulting in concern about degradation in frequency efficiency.

In NPL 1, as a second method, a system in which, when the sizes of pieces of data addressed to terminal apparatuses are different from one another, a timing of transmission of an Ack that is an acknowledgement from a terminal apparatus is changed for the terminal apparatus has been proposed. In the method described in NPL 1, since setting of a redundant area as in padding is not performed, degradation in frequency efficiency may be avoided. However, in the method described in NPL 1, a base station needs to perform a reception operation in a channel adjacent to a channel in which the base station apparatus performs a transmission operation, resulting in concern about an adverse effect such as interference between the adjacent channels.

In PTL 1, a method in which data addressed to multiple terminal apparatuses is multiplexed in the time direction so that the lengths of transmission frames are adjusted has been proposed. However, in the method described in PTL 1, in resources of the same frequency, space, code, or the like, temporal multiplexing is performed. For example, as typified by wireless LAN systems, after a terminal apparatus completes adequate reception of a transmission frame, the terminal apparatus transmits an acknowledgement immediately. Therefore, terminal apparatuses need to make an arrangement about how to transmit acknowledgements.

The present invention is made to address such issues, and its object is to provide a base station apparatus and a terminal apparatus that efficiently use radio resources and that may construct preferable transmission frames which enable a transmission time of the frames to be reduced, in a transmission system in which data addressed to multiple terminal apparatuses is multiplexed.

### Solution to Problem

To attain the above-described object, the present invention takes the following measures. That is, a base station apparatus of the present invention includes a base station apparatus transmitting a transmission frame to a terminal apparatus by using at least one of radio resources. The base station apparatus includes a physical-layer frame generating unit and a radio transmission unit. The physical-layer frame generating unit divides a transmission frame addressed to the terminal apparatus into a plurality of transmission frames, and generates physical layer frames in such a manner that the transmission frames obtained through division are transmitted in a plurality of radio resources. The radio transmission unit transmits the generated physical layer frames to the terminal apparatus in the plurality of radio resources.

Thus, a transmission frame addressed to a terminal apparatus is divided into multiple transmission frames. Physical layer frames are generated so that the transmission frames obtained through the division are transmitted in multiple radio resources. Therefore, the radio resources may be efficiently used, and a transmission time of the transmission frame may be reduced.

### ADVANTAGEOUS EFFECTS OF INVENTION

According to the present invention, radio resources may be efficiently used, and a transmission time of a transmission frame may be reduced.

### BRIEF DESCRIPTION OF DRAWINGS

FIG. 1 is a diagram illustrating an exemplary management range 3101 of a wireless communication system according to the present embodiment.

FIG. 2 is a diagram illustrating an exemplary apparatus configuration of a base station apparatus 1101.

FIG. 3 is a diagram illustrating an exemplary apparatus configuration of a terminal apparatus 2100.

FIG. 4 is a diagram illustrating exemplary subchannels allocated on the frequency axis.

FIG. 5 is a diagram illustrating exemplary DL-MU transmission performed when a frame-length adjusting unit 11013b does not operate (when a physical-layer frame generating unit 11013a is connected to a radio transmission unit 11013c).

FIG. 6 is a diagram illustrating exemplary DL-MU transmission performed when the frame-length adjusting unit 11013b operates.

FIG. 7 is a diagram illustrating other exemplary DL-MU transmission performed when the frame-length adjusting unit 11013b operates.

FIG. 8 is a diagram illustrating exemplary first resource allocation information used in the case of the example in FIG. 6.

FIG. 9 is a diagram illustrating exemplary DL-MU transmission performed when the frame-length adjusting unit 11013b operates.

FIG. 10 is a diagram illustrating an exemplary management range 3201 of a wireless communication system according to the present embodiment.

FIG. 11 is a diagram illustrating an exemplary apparatus configuration of a base station apparatus 1201.

FIG. 12 is a diagram illustrating an exemplary apparatus configuration of a terminal apparatus 2200.

FIG. 13 is a diagram illustrating exemplary UL-MU transmission performed when a frame-length adjusting unit 12012 operates.

### DESCRIPTION OF EMBODIMENTS

A communication system according to the present embodiment includes a radio transmitting apparatus (access point, base station apparatus: Access point, base station apparatus), and multiple radio receiving apparatuses (stations, terminal apparatuses: Stations, terminal apparatuses). A network including a base station apparatus and terminal apparatuses is designated as a basic service set (BSS: Basic service set, management range). Base station apparatuses and terminal apparatuses are also collectively designated as wireless LAN apparatuses.

A base station apparatus and terminal apparatuses in a BSS communicate with one another on the basis of CSMA/CA (Carrier sense multiple access with collision avoidance). In the present embodiment, the infrastructure mode in which a base station apparatus communicates with multiple terminal apparatuses is used. However, the method of the present embodiment may be also performed in the ad hoc mode in which terminal apparatuses directly communicate with one another. In the ad hoc mode, a terminal apparatus serves as a base station apparatus, and forms a BSS. A BSS in the ad hoc mode is also designated as an IBSS (Independent Basic Service Set). In the description below, a terminal apparatus forming an IBSS in the ad hoc mode is regarded as a base station apparatus.

In an IEEE 802.11 system, each apparatus is capable of transmitting transmission frames that are of multiple frame types and that have a common frame format. A transmission frame is defined in each of the physical (Physical: PHY) layer, the medium access control (Medium access control: MAC) layer, and the logical link control (LLC: Logical Link Control) layer.

A transmission frame in the PHY layer is designated as a physical protocol data unit (PPDU: PHY protocol data unit, physical layer frame). A PPDU includes a physical layer header (PHY header) including header information for performing signal processing in the physical layer, and a physical service data unit (PSDU: PHY service data unit, MAC layer frame) that is a data unit processed in the physical layer. A PSDU may include an aggregated MPDU (A-MPDU: Aggregated MPDU) in which multiple MAC protocol data units (MPDUs: MAC protocol data units) that serve as a retransmission unit in a radio section are aggregated.

A PHY header includes reference signals, such as a short training field (STF: Short training field) used for detection, synchronization, and the like of signals, and a long fining field (LTF: Long training field) used to obtain channel information for data demodulation, and a control signal, such as a signal (Signal: SIG) including control information for data demodulation. An STF is classified according to a corresponding standard into legacy-STF (L-STF: Legacy-STF), high throughput-STF (HT-STF: High throughput-STF), very high throughput-STF (VHT-STF: Very high throughput-STF), and the like. Similarly, an LTF and a SIG are classified into L-LTF, HT-LTF, VHT-LTF, L-SIG, HT-SIG, and VHT-SIG. VHT-SIG is further classified into VHT-SIG-A and VHT-SIG-B.

A PPDU is modulated according to a corresponding standard. For example, according to the IEEE 802.11n standard, a PPDU is modulated into an orthogonal frequency division multiplexing (OFDM: Orthogonal frequency division multiplexing) signal.

An MPDU includes a MAC layer header (MAC header) including header information for performing signal processing in the MAC layer, a MAC service data unit (MSDU: MAC service data unit) or frame body that is a data unit processed in the MAC layer, and a frame check unit (Frame check sequence: FCS) for checking if the frame has an error. Multiple MSDUs may be aggregated as an aggregated MSDU (A-MSDU: Aggregated MSDU).

The frame types of a transmission frame in the MAC layer are broadly classified into three types: a management frame for managing an association state and the like between apparatuses; a control frame for managing a communication state between apparatuses; and a data frame including actual transmission data. Each of the three types is further classified into multiple subframe types. A control frame includes an acknowledge (Ack: Acknowledge) frame, a request-to-send (RTS: Request to send) frame, and a clear-to-send (CTS: Clear to send) frame. A management frame includes a beacon (Beacon) frame, a probe request (Probe request) frame, a probe response (Probe response) frame, an authentication (Authentication) frame, an association request (Association request) frame, and an association response (Association response) frame. A data frame includes a data (Data) frame and a polling (CF-poll) frame. Each apparatus may grasp the frame type and the subframe type of a received frame by reading information in a frame control field included in the MAC header.

An Ack may include a Block Ack. A Block Ack may be used to transmit an acknowledgement for multiple MPDUs.

A beacon frame includes a field (Field) for describing an interval (Beacon interval) in which a beacon is transmitted, and a field (Field) for describing information (SSID: Service set identifier and the like) for identifying a base station apparatus. A base station apparatus is capable of broadcasting a beacon frame periodically to a BSS. A terminal apparatus is capable of grasping a base station apparatus around the terminal apparatus by receiving a beacon frame. An operation in which a terminal apparatus grasps a base station apparatus on the basis of a beacon frame broadcasted by the base station apparatus is designated as passive scanning (Passive scanning). In contrast, an operation in which a terminal apparatus searches for a base station apparatus by broadcasting a probe request frame in a BSS is designated as active scanning (Active scanning). A base station apparatus is capable of transmitting a probe response frame as a response to the probe request frame, and information described in the probe response frame is equivalent to information in a beacon frame.

After a terminal apparatus recognizes a base station apparatus, the terminal apparatus performs an association process on the base station apparatus. The association process is classified into an authentication (Authentication) procedure and an association (Association) procedure. The terminal apparatus transmits an authentication frame (authentication request) to the base station apparatus with which establishment of association is to be made. When the base station apparatus receives the authentication frame, the base station apparatus transmits, to the terminal apparatus, an authentication frame (authentication response) including a status code indicating whether or not authentication of the terminal apparatus has been successfully performed. The terminal apparatus reads the status code described in the authentication frame so as to determine whether or not the base station apparatus has given permission for authentication of the terminal apparatus. The base station apparatus and the terminal apparatus are capable of receiving/transmitting multiple authentication frames.

Subsequent to the authentication procedure, the terminal apparatus transmits an association request frame in order to perform the association procedure on the base station apparatus. When the base station apparatus receives the association request frame, the base station apparatus determines whether or not association with the terminal apparatus is to be permitted, and transmits an association response frame in order to notify the determination result. In the association response frame, an association identification number (AID: Association identifier) for identifying the terminal apparatus is described in addition to a status code indicating whether or not the association process has been permitted. The base station apparatus is capable of managing multiple terminal apparatuses by setting different AIDS to the respective terminal apparatuses which have been given association permission by the base station apparatus.

After the association process, the base station apparatus and the terminal apparatus perform actual data transmission. In an IEEE 802.11 system, distributed coordination function (DCF: Distributed Coordination Function), point coordination function (PCF: Point Coordination Function), and functions (enhanced distributed channel access (EDCA: Enhanced distributed channel access), hybrid coordination function (HCF: Hybrid coordination function), and the like) obtained by enhancing these are defined. A description will be made below by taking, as an example, a case in which a base station apparatus transmits signals to terminal apparatuses in DCF.

In DCF, prior to communication, a base station apparatus and a terminal apparatus perform carrier sensing (CS: Carrier sense) for checking the usage of a radio channel around the base station apparatus and the terminal apparatus. For example, when the base station apparatus that serves as a transmitting station receives a signal higher than a predetermined clear channel assessment level (CCA level: Clear channel assessment level) in the radio channel, the base station apparatus postpones transmission of a transmission frame in the radio channel. Hereinafter, a state in which a signal of the CCA level or larger is detected in the radio channel is designated as the busy (Busy) state. A state in which a signal of the CCA level or larger is not detected is designated as the idle (Idle) state. Thus, CS performed on the basis of the power (received power level) of a signal that is actually received by each apparatus is designated as physical carrier sensing (physical CS). The CCA level is also designated as a carrier sense level (CS level) or a CCA threshold (CCA threshold: CCAT). When the base station apparatus and the terminal apparatus detect a signal of the CCA level or larger, the base station apparatus and the terminal apparatus start demodulating at least a signal in the PHY layer.

The base station apparatus performs carrier sensing during an inter frame space (IFS: Inter frame space) according to the type of a transmission frame that is to be transmitted, and determines whether the radio channel is in the busy state or the idle state. A period in which the base station apparatus performs carrier sensing is different depending on the frame type and the subframe type of a transmission frame that is to be transmitted by the base station apparatus. In an IEEE 802.11 system, multiple IFSs having different periods are defined. The defined IFSs are a short inter frame space (SIFS: Short IFS) used for a transmission frame given the highest priority, a polling inter frame space (PCF IFS: PIFS) used for a transmission frame given relatively high priority, a distributed-coordination inter frame space (DCF IFS: DIFS) used for a transmission frame given the lowest priority, and the like. When a base station apparatus transmits a data frame in DCF, the base station apparatus uses the DIFS.

After waiting lust for a DIFS, the base station apparatus further waits just for a random backoff time for preventing frame collision. In an IEEE 802.11 system, a random backoff time designated as a contention window (CW: Contention window) is used. In CSMA/CA, as a precondition, a transmission frame transmitted by a certain transmitting station is received by a receiving station without interference from a different transmitting station. Therefore, when transmitting stations transmit transmission frames at the same timing, the frames collide with each other, resulting in a state in which the receiving station fails to successfully receive the frames. Accordingly, before start of transmission, each transmitting station waits just for a time that is randomly set, so that frame collision is avoided. When the base station apparatus determines, through carrier sense, that a radio channel is in the idle state, the base station apparatus starts countdown of a CW. When the CW becomes zero, the base station apparatus then obtains transmission right, and may transmit a transmission frame to the terminal apparatus. In countdown of a CW, when the base station apparatus determines that the radio channel is in the busy state through carrier sense, the base station apparatus stops countdown of the CW. When the radio channel enters the idle state, subsequent to the above-description IFS, the base station apparatus restarts countdown of the remaining CW.

The terminal apparatus that serves as a receiving station receives the transmission frame, reads the PHY header of the transmission frame, and demodulates the received transmission frame. The terminal apparatus may recognize whether or not the transmission frame is addressed to the terminal apparatus, by reading the MAC header of the demodulated signal. Alternatively, the terminal apparatus may determine the destination of the transmission frame on the basis of information described in the PHY header (for example, the group identification number (GID: Group identifier) described in a VHT-SIG-A).

In the case where the terminal apparatus determines that the received transmission frame is addressed to the terminal apparatus and where the transmission frame has been demodulated without an error, the terminal apparatus has to transmit an ACK frame that indicates that the frame has been successfully received, to the base station apparatus that is a transmitting station. The ACK frame is one of the transmission frames of the highest priority which are transmitted after waiting only for an SIFS period (without waiting for a random backoff time). Upon reception of the ACK frame transmitted from the terminal apparatus, the base station apparatus ends a series of communication processes. When the terminal apparatus fails to successfully receive the frame, the terminal apparatus does not transmit an ACK. Therefore, after the base station apparatus transmits the frame, when the base station apparatus has not received an ACK frame from a receiving station for a certain period (an SIFS+the length of an ACK frame), the base station apparatus regards the communication as a failure, and ends the communication. Thus, end of one communication operation (also designated as a burst) in an IEEE 802.11 system is always determined by determining whether or not an ACK frame has been received, except for special cases, such as a case of transmission of a broadcast signal such as a beacon frame and a case of use of fragmentation for dividing transmission data.

When the terminal apparatus determines that the received transmission frame is not addressed to the terminal apparatus, the terminal apparatus sets a network allocation vector (NAV: Network allocation vector) on the basis of the length (Length) of the transmission frame which is described in the PHY header or the like. The terminal apparatus does not try to communicate for a period that is set in the NAV. That is, the terminal apparatus performs the same operation as in the case where it is determined that the radio channel is in the busy state through physical CS, for the period that is set in the NAV. Therefore, the communication control using an NAV is also designated as virtual carrier sense (virtual CS). In addition to the case in which an NAV is set on the basis of information described in the PHY header, the NAV is also set by using a request-to-send (RTS: Request to send) frame or a clear-to-send (CTS: Clear to send) frame which is introduced to solve the hidden node problem.

In DCF, each apparatus performs carrier sensing, and autonomously obtains transmission right. In contrast, in PCF, control station designated as a point coordinator (PC: Point coordinator) controls transmission right of each apparatus in a BSS. Typically, a base station apparatus serves as a PC, and obtains transmission right of the terminal apparatuses in a BSS.

A communication period in PCF includes a contention free period (CFP: Contention free period) and a contention period (CP: Contention period). During a CP, communication is performed on the basis of DCF described above, and a PC controls transmission right in a CFP. A base station apparatus that serves as a PC broadcast a beacon frame describing a CFP period (CFP Max duration) and the like, in a BSS prior to communication in PCF. A PIFS is used in transmission of a beacon frame broadcasted upon start of transmission in PCF, and the beacon frame is transmitted without waiting for a CW. A terminal apparatus receiving the beacon frame sets the CEP period described in the beacon frame to an NAV. After that, until the NAV has elapsed or a signal (for example, a data frame including CF-end) for broadcasting end of the CFP in the BSS is received, only when the terminal apparatus receives a signal (for example, a data frame including CF-poll) for signaling acquisition of transmission right which is transmitted from the PC, the terminal apparatus may obtain transmission right. In a CFP period, packet collision does not occur in the same BSS. Therefore, each terminal apparatus does not wait for a random backoff time used in DCF.

### First Embodiment

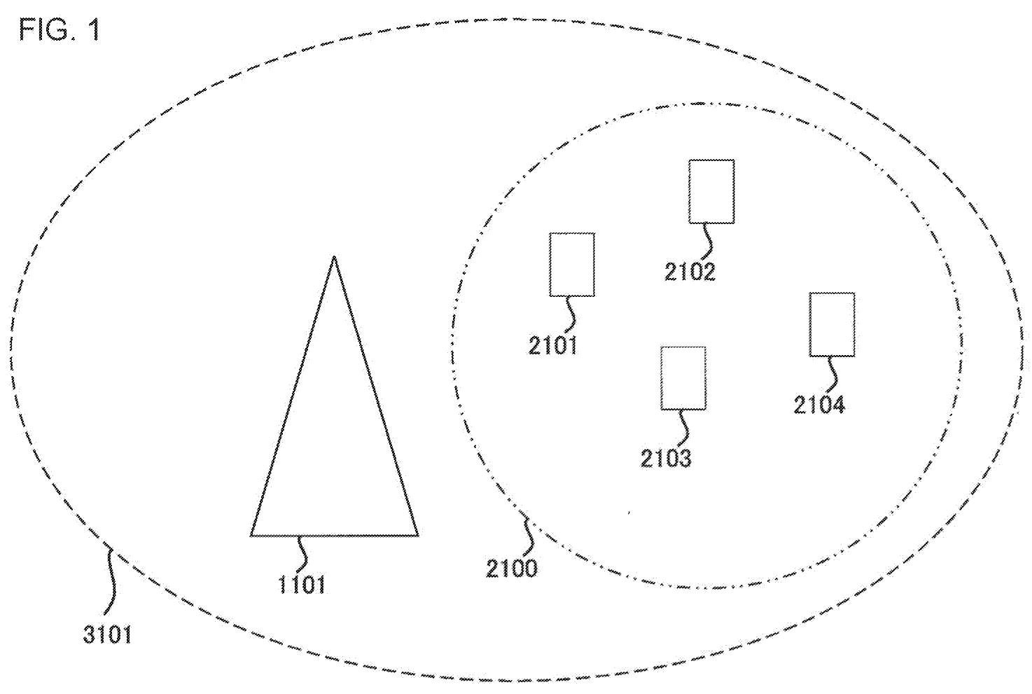

FIG. 1 is a diagram illustrating an exemplary management range 3101 of a wireless communication system according to the present embodiment. The management range 3101 includes a base station apparatus 1101 and terminal apparatuses 2101 to 2104. The example in FIG. 1 includes four terminal apparatuses. The method according to the present embodiment may be implemented as long as the management range 3101 includes two or more terminal apparatuses. Hereinafter, the terminal apparatuses 2101 to 2104 are also referred to as terminal apparatuses 2100. The base station apparatus 1101 may perform multi-user transmission (Multi-user Transmission) on multiple terminal apparatuses 2100. Examples of multi-user transmission include OFDMA (Orthogonal Frequency Division Multiple Access), MU-MIMO (Multi User Multiple Input Multiple Output), and CDMA (Code Division Multiple Access). A description will be made below under the assumption that the base station apparatus 1101 performs OFDMA. The present invention may employ another multi-user transmission scheme. Each of the terminal apparatuses 2100 is capable of receiving a transmission frame for multi-user transmission (hereinafter referred to as an “MU frame”) which is generated by the base station apparatus 1101. The terminal apparatus 2100 has a function of selecting data addressed to the terminal apparatus 2100 from the received MU frame. A method in which the terminal apparatus 2100 obtains information that is used to select data addressed to the terminal apparatus 2100 from a MU frame and that is about where the data addressed to the terminal apparatus 2100 is located in the MU frame will be described below.

When a terminal apparatus 2100 successfully receives data transmitted by the base station apparatus 1101, the terminal apparatus 2100 transmits an ACK frame addressed to the base station apparatus 1101. The base station apparatus 1101 receives the ACK frame transmitted by the terminal apparatus 2100, and thereby recognizes completion of transmission of the data.

Hereinafter, an operation in which the base station apparatus 1101 performs multi-user transmission to the multiple terminal apparatuses 2100 is referred to as DL-MU transmission. In DL-MU transmission, the multiple terminal apparatuses 2100 prepare transmission of ACK frames. The method in which the multiple terminal apparatuses 2100 transmit ACK frames addressed to the base station apparatus 1101 at the same time is referred to as UL-MU transmission.

The UL-MU transmission is not limited to the above-described method. An operation in which the multiple terminal apparatuses 2100 transmit their respective transmission frames in a certain radio resource in a multiplex way and in which the base station apparatus 1101 receives the multiplexed transmission frame may be referred to as UL-MU transmission.

The base station apparatus 1101 has a function of DL-MU transmission. In the present embodiment, the lengths of the physical layer headers for the terminal apparatuses 2100 may be different from one another. For example, in the specification of IEEE 802.11, the length of a physical layer header may depend on the number of transmission streams. The present invention may be carried out even when the lengths of physical layer headers for the terminal apparatuses 2100 are different from one another.

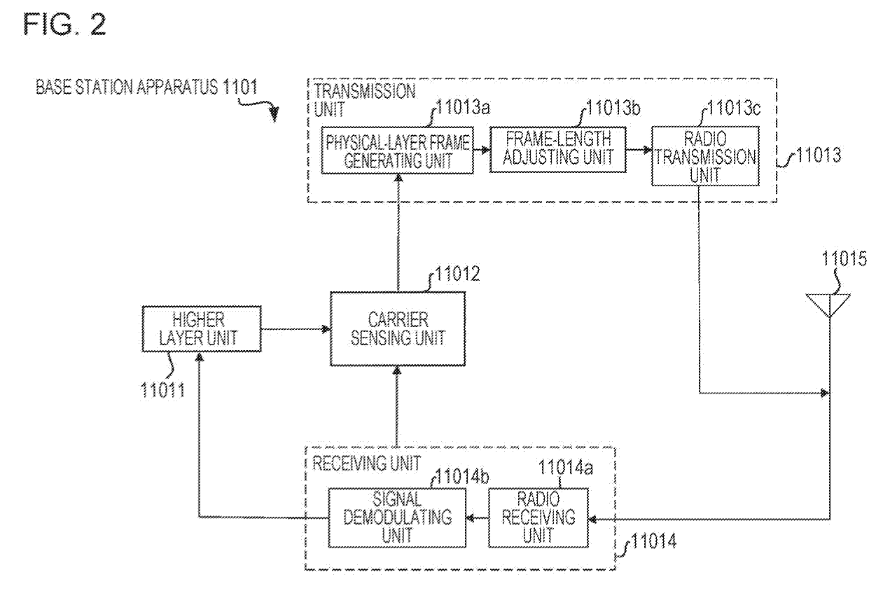

FIG. 2 is a diagram illustrating an exemplary apparatus configuration of the base station apparatus 1101. The base station apparatus 1101 has a configuration including a higher layer unit 11011, a carrier sensing unit 11012, a transmission unit 11013, a receiving unit 11014, and an antenna unit 11015.

The higher layer unit 11011 is connected to other networks, and has a function of notifying the carrier sensing unit 11012 of information associated with a transmission frame. A description will be made below under the assumption that a transmission frame is defined in the MAC layer. Alternatively, a transmission frame according to the present embodiment may be defined in the LLC layer, the physical layer, or a higher layer.

The carrier sensing unit 11012 has a function of making a determination about whether transmission is to be performed, on the basis of carrier sense. In the present embodiment, when the base station apparatus 1101 performs OFDMA transmission, the carrier sensing unit 11012 may perform carrier sensing on multiple channels. A method of performing carrier sensing on multiple channels and a method of OFDMA transmission will be described below.

The transmission unit 11013 includes a physical-layer frame generating unit 11013a, a frame-length adjusting unit 11013b, and a radio transmission unit 11013c. The physical-layer frame generating unit 11013a has a function of generating a physical layer frame from a transmission frame transmitted from the carrier sensing unit 11012. The physical-layer frame generating unit 11013a performs error correction coding, modulation, precoding-filter multiplication, and the like on the transmission frame. The physical-laver frame generating unlit 11013a notifies the frame-length adjusting unit 11013b of the generated physical layer frame.

The frame-length adjusting unit 11013b has a function of generating an MU frame suitable for DL-MU transmission. Operations of the frame-length adjusting unit 11013b will be described in detail below.

The radio transmission unit 11013c converts the MU frame generated by the frame-length adjusting unit 11013b into a signal in a radio frequency (RF: Radio Frequency) band, and generates a radio frequency signal. The processes performed by the radio transmission unit 11013c include digital-analog conversion, filtering, and frequency conversion from a base band to an RF band.

The receiving unit 11014 includes a radio receiving unit 11014a and a signal demodulating unit 11014b. The receiving unit 11014 has a function of calculating a received power level from an RF band signal received by the antenna unit 11015. However, the method of calculating a received power level is not limiting. The receiving unit 11014 notifies the carrier sensing unit 11012 of information about the calculated received power level. The carrier sensing unit 11012 may make a determination about whether transmission is to be performed, on the basis of the information about a received power level which is transmitted by the receiving unit 11014.

The radio receiving unit 11014a has a function of converting an RF band signal received by the antenna unit 11015 into a base band signal and generating a physical layer signal (for example, a physical layer frame). The processes performed by the radio receiving unit 11014a include a frequency conversion process from an RF band to a base band, filtering, and analog-digital conversion.

The signal demodulating unit 11014b has a function of demodulating the physical layer signal generated by the radio receiving unit 11014a. The processes performed by the signal demodulating unit 11014b include channel equalization, de-mapping, and error correction decoding. The signal demodulating unit 11014b may extract, for example, information included in the physical layer header, information included in the MAC header, and information included in the transmission frame from the physical layer signal. The signal demodulating unit 11014b may notify the higher layer unit 11011 of the extracted information. The signal demodulating unit 11014b may extract one or some of the information included in the physical layer header, the information included in the MAC header, and the information included in the transmission frame.

The antenna unit 11015 has a function of transmitting a radio frequency signal generated by the radio transmission unit 11013c through a wireless space to the terminal apparatuses 2100. The antenna unit 11015 has a function of receiving radio frequency signals transmitted from the terminal apparatuses 2100. When the base station apparatus 1101 performs carrier sensing, the antenna unit 11015 has a function of receiving a signal in the channel in the wireless space.

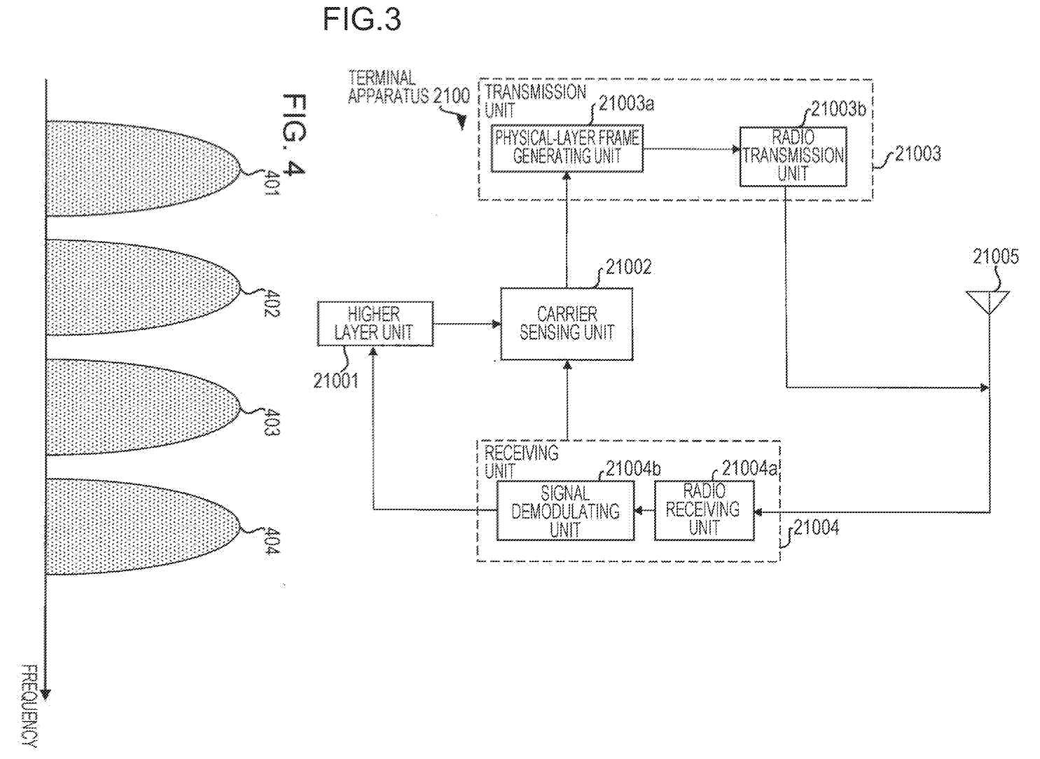

FIG. 3 is a diagram illustrating an exemplary apparatus configuration of a terminal apparatus 2100. The terminal apparatus 2100 includes a higher layer unit 21001, a carrier sensing unit 21002, a transmission unit 21003, a receiving unit 21004, and an antenna unit 21005.

The higher layer unit 21001 is connected to other networks, and has a function of notifying the carrier sensing unit 21002 of information associated with a transmission frame.

The carrier sensing unit 21002 has a function of making a determination about whether transmission is to be performed, on the basis of carrier sense. The transmission unit 21003 includes a physical-layer frame generating unit 21003a and a radio transmission unit 21003b.

The physical-layer frame generating unit 21003a has a function of generating a physical layer frame from a transmission frame transmitted from the carrier sensing unit 21002. The physical-layer frame generating unit 21003a performs error correction coding, modulation, precoding-filter multiplication, and the like on the transmission frame. The physical-layer frame generating unit 21003a notifies the radio transmission unit 21003b of the generated physical layer frame.

The radio transmission unit 21003b converts the physical layer frame generated by the physical-layer frame generating unit 21003a into a signal in a radio frequency (RF: Radio Frequency) band, and generates a radio frequency signal. The processes performed by the radio transmission unit 21003b include digital-analog conversion, filtering, and frequency conversion from a base band to an RF band.

The receiving unit 21004 includes a radio receiving unit 21004a and a signal demodulating unit 21004b. The receiving unit 21004 has a function of calculating a received power level from an RF band signal received by the antenna unit 21005. However, the method of calculating a received power level is not limiting. The receiving unit 21004 notifies the carrier sensing unit 21002 of information about the calculated received power level. The carrier sensing unit 21002 may make a determination about whether transmission is to be performed, on the basis of the information about a received power level which is transmitted by the receiving unit 21004.

The radio receiving unit 21004a has a function of converting an RF band signal received by the antenna unit 21005 into a base band signal and generating a physical layer signal (for example, a physical layer frame, an MU frame, and the like). The processes performed by the radio receiving unit 21004a include a frequency conversion process from an RF band to a base band, filtering, and analog-digital conversion.

The signal demodulating unit 21004b has a function of demodulating the physical layer signal generated by the radio receiving unit 21004a. The processes performed by the signal demodulating unit 21004b include channel equalization, de-mapping, and error correction decoding. The signal demodulating unit 21004b may extract, for example, information included in the physical layer header, information included in the MAC header, and information included in the transmission frame from the physical layer signal. The signal demodulating unit 21004b may notify the higher layer unit 21001 of the extracted information. The signal demodulating unit 21004b may extract one or some of the information included in the physical layer header, the information included in the MAC header, and the information included in the transmission frame.

The signal demodulating unit 21004b has a function of demodulating an MU frame transmitted by the base station apparatus 1101. A method of demodulating an MU frame will he described below. The antenna unit 21005 has a function of transmitting a radio frequency signal generated by the radio transmission unit 21003b through a wireless space to the base station apparatus 1101. The antenna unit 21005 has a function of receiving a radio frequency signal transmitted from the base station apparatus 1100. When the terminal apparatus 2100 performs carrier sensing, the antenna unit 21005 has a function of receiving a signal in the channel in the wireless space.

FIG. 4 is a diagram illustrating exemplary subchannels allocated on the frequency axis. FIG. 4 illustrates an example in which subchannels 401 to 404 are allocated on the frequency axis. The subchannels 401 to 404 are collectively referred to as subchannels 400. In OFDMA transmission, different terminal apparatuses 2100 are assigned to the respective subchannels 400, achieving DL-MU transmission.

The IEEE 802.11 standard supports multiple 20-MHz channels. For example, the subchannels 400 may correspond to the respective 20-MHz channels supported by the IEEE 802.11 standard. In this example, this corresponds to a state in which the base station apparatus 1101 assigns the different terminal apparatuses 2100 to the respective 20-MHz channels. In this case, it is preferable that the base station apparatus 1101 make a determination about whether transmission is to be performed, on the basis of carrier sense on each 20-MHz channel. The method in which the base station apparatus 1101 makes determinations about whether transmission is to be performed, on the basis of carrier sense on multiple 20-MHz channels is not limiting. After the base station apparatus 1101 calculates a received power level individually on each subchannel 400, the base station apparatus 1101 may perform carrier sensing, or may perform carrier sensing on the basis of the average received power level obtained by averaging the received power levels of all of the subchannels 400.

For example, the base station apparatus 1101 may divide a 20-MHz channel supported by the IEEE 802.11 standard, and may assign the terminal apparatuses 2100 to the respective subchannels 400. In this example, each of the subchannels 400 has a band width of 20 MHz/4=5 MHz. In this case, after the base station apparatus 1101 calculates a received power level only for a single 20-MHz channel, the base station apparatus 1101 may perform carrier sensing, or may perform carrier sensing for every 5 MHz. The base station apparatus 1101 may divide a 20-MHz channel into units having a band width other than 5 MHz, or does not necessarily divide a 20-MHz channel evenly.

The method in which the base station apparatus 1101 assigns the subchannels to the terminal apparatuses 2100 is not limited to the above-described method. For example, two or more certain subchannels 400 may be assigned to the same terminal apparatus 2100. For example, the base station apparatus 1101 may assign the subchannels 401 to 402 to the terminal apparatus 2101, the subchannel 403 to the terminal apparatus 2102, and the subchannel 404 to the terminal apparatus 2103.

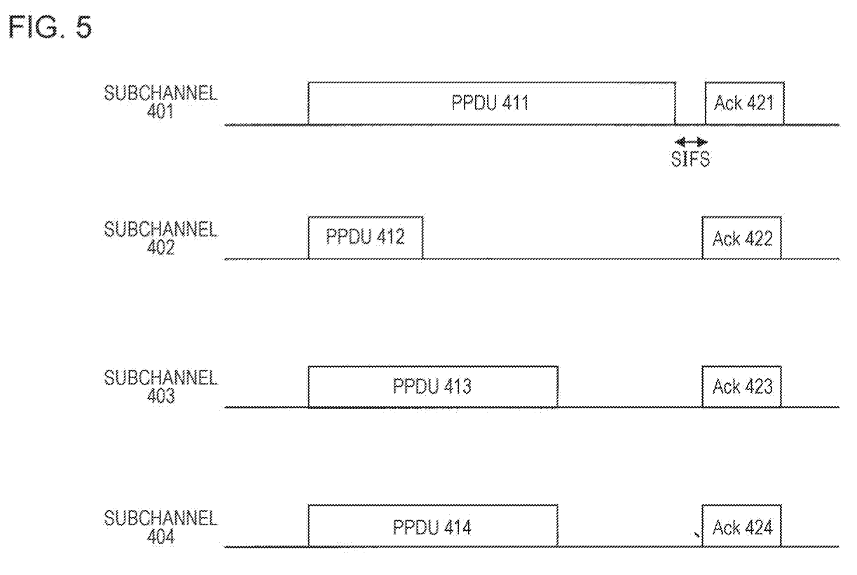

FIG. 5 is a diagram illustrating exemplary DL-MU transmission performed when the frame-length adjusting unit 11013b operates so as to connect the physical-layer frame generating unit 11013a to the radio transmission unit 11013c (or when the physical-layer frame generating unit 11013a is equivalently connected to the radio transmission unit 11013c). As illustrated in the example in FIG. 5, when the sizes of PPDUs 411 to 414 (hereinafter also referred to as “PPDUs 410” collectively) transmitted to the terminal apparatuses are different from one another, there arises a problem of transmission timing of Acks. The terminal apparatuses 2100 have to transmit Acks 421 to 424 (hereinafter also referred to as “Acks 420” collectively) after the base station apparatus 1101 completes the DL-MU transmission. In the example in FIG. 5, the DL-MU transmission period of the base station apparatus 1101 is until completion of transmission of the PPDU 411. Therefore, after completion of transmission of the PPDU 411, the terminal apparatuses 2100 wait for a given period (for example, an SIFS period). Then, the terminal apparatuses 2100 transmit the Acks 420. Therefore, it is preferable that the base station apparatus 1101 adjust the lengths of the DL-MU frames in order that the frequency efficiency is improved. One or all of the PPDUs 410 may constitute an A-MPDU.

The method of transmitting the Acks 420 which is illustrated in FIG. 5 corresponds to UL-MU transmission. The method of transmitting Acks which is performed by the terminal apparatuses 2100 according to the present embodiment is not necessarily UL-MU transmission. For example, the Acks 420 may be transmitted in different time slots (time division transmission).

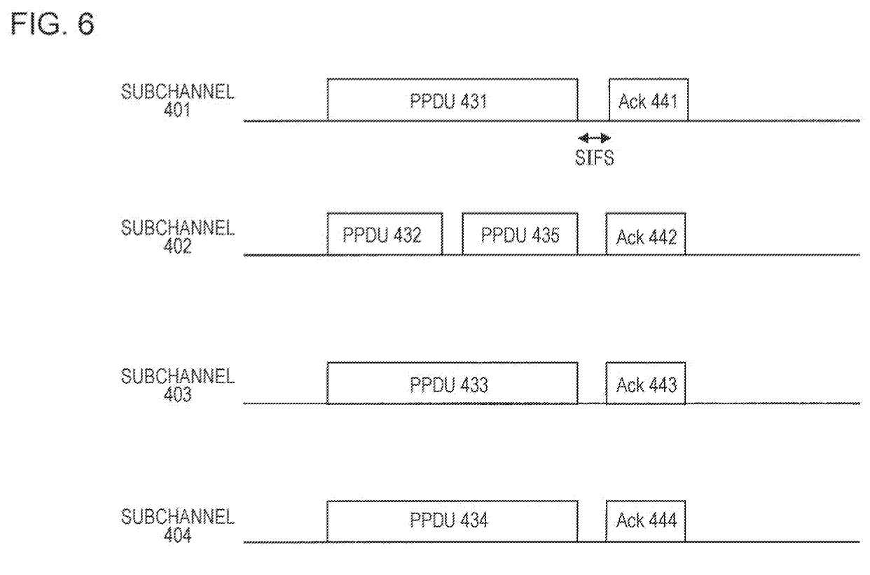

FIG. 6 is a diagram illustrating exemplary DL-MU transmission performed when the frame-length adjusting unit 11013b adjusts DL-MU frames. The frame-length adjusting unit 11013b generates PPDUs 431 to 435 (hereinafter also referred to as “PPDUs 430” collectively). For example, the PPDU 431 and the PPDU 435 are two PPDUs for the same terminal apparatus 2100. In this example, the subchannel 402 includes PPDUs for two different terminal apparatuses in the DL-MU transmission period. In the example in FIG. 6, it is expected that the frame-length adjusting function of the frame-length adjusting unit will cause a DL-MU transmission period of the base station apparatus 1101 to be reduced. Therefore, the terminal apparatuses 2100 may transmit Acks at a timing earlier than the timing in the example in FIG. 5. The PPDU 435 may have a configuration that does not include a part or all of the physical layer header.

As illustrated in FIG. 6, the base station apparatus 1101 may set a waiting time (for example, an SIFS, a PIFS, an RIFS, a DIFS, an AIFS, or another waiting time) between the PPDU 432 and the PPDU 435, or may continuously transmit the PPDU 432 and the PPDU 435 without waiting for a waiting time.

The present invention may be described as follows. The base station apparatus 1101 transmits the PPDU 431 addressed to one of the terminal apparatuses 2100 (for example, the terminal apparatus 2101) in a first radio resource (for example, the subchannel 401). A section in which the PPDU 431 is transmitted is also referred to as a first frame section. The base station apparatus 1101 transmits the PPDU 435 addressed to the terminal apparatus 2101 by using a second radio resource (for example, the subchannel 402). A section in which the PPDU 435 is transmitted is also referred to as a second frame section.

The base station apparatus 1101 transmits a physical layer frame including the first frame section by using the first radio resource, and transmits a physical layer frame including the second frame section by using the second radio resource, achieving reduction of a DL-MU frame. Preferably, in order to adequately receive physical layer frames including the first frame section and the second frame section, the terminal apparatus 2101 has some or all of information about the first radio resource, information about the second radio resource, information about the first frame section, and information about the second frame section. That is, the base station apparatus 1101 may transmit, to the terminal apparatus 2101, some or all of the information about the first radio resource, the information about the second radio resource, the information about the first frame section, and the information about the second frame section. Further, the base station apparatus 1101 may also transmit a physical layer frame including a third frame section by using a third radio resource. That is, the base station apparatus 1101 may transmit physical layer frames including multiple frame sections by using multiple radio resources. The base station apparatus 1101 has a function of performing DL-MU transmission by using multiple radio resources.

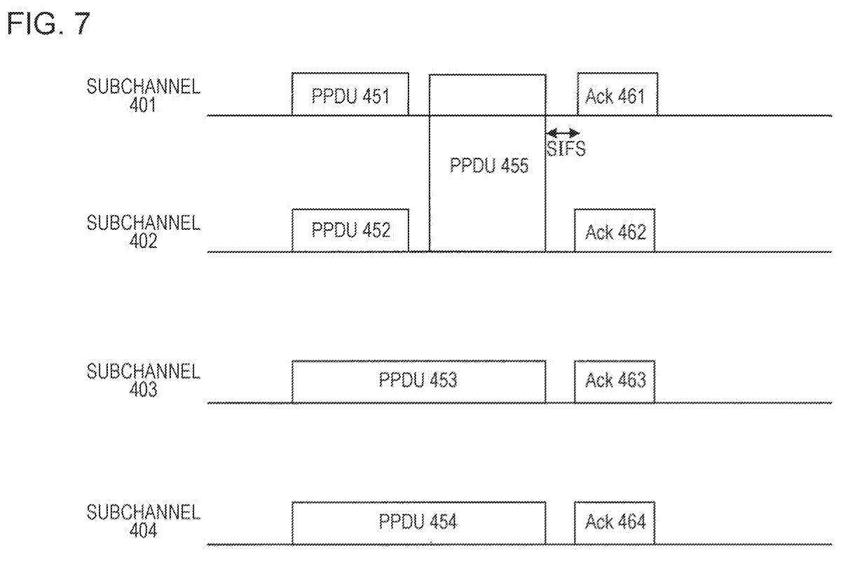

FIG. 7 is a diagram illustrating other exemplary DL-MU transmission performed when the frame-length adjusting unit 11013b operates. The frame-length adjusting unit 11013b generates PPDUs 451 to 455 (hereinafter also referred to as “PPDUs 450”). For example, the PPDU 451 and the PPDU 455 are two PPDUs for the same terminal apparatus 2100. The PPDU 455 is a channel aggregated PPDU generated by aggregating the subchannels 401 to 402 (Channel Aggregation). in the example in FIG. 7, it is expected that the frame-length adjusting function of the frame-length adjusting unit will cause a DL-MU transmission period of the base station apparatus 1101 to be reduced. Therefore, the terminal apparatuses 2100 may transmit Acks at a timing earlier than the timing in the example illustrated in FIG. 5.

The examples in FIGS. 6 and 7 indicate that each of the PPDU 431 and the PPDU 451 having a large PPDU length is offloaded to the subchannel 402 including a respective one of the PPDU 432 and the PPDU 452 having a small PPDU length, enabling a DL-MU transmission period to he reduced.

A terminal apparatus 2100 may transmit an Ack in a subchannel in which a PPDU addressed to the terminal apparatus 2100 is received. For example, in the example in FIG. 6, it is preferable that a terminal apparatus 2100 receiving the PPDU 431 and the PPDU 435 transmit an Ack 441 to the base station apparatus 1101.

In the example in FIG. 7, a terminal apparatus 2100 having received the PPDU 451 and the PPDU 455 may complete the reception operation by notifying the base station apparatus 1101 of an Ack 461.

The method of transmitting an Ack is not particularly limiting in the present embodiment. For example, a terminal apparatus 2100 may transmit an Ack in one of subchannels 400 in which PPDUs just after physical layer headers are received.

Another method in the example in FIG. 7 will be described. For example, a terminal apparatus 2100 receiving the PPDU 451 and the PPDU 455 may be instructed to perform a receiving operation on the subchannel 401 and the subchannel 402 in a DL-MU transmission period. The terminal apparatus 2100 may extract only PPDUs addressed to the terminal apparatus 2100 on the basis of first resource allocation information.

The present invention may be interpreted as follows. The base station apparatus 1101 transmits the PPDU 451 addressed to one of the terminal apparatuses 2100 (for example, the terminal apparatus 2101) in a first radio resource (for example, the subchannel 401). A section in which the PPDU 451 is transmitted is also referred to as a first frame section. The base station apparatus 1101 transmits the PPDU 455 addressed to the terminal apparatus 2101 by using a second radio resource (for example, the subchannel 402). A section in which the PPDU 455 is transmitted is also referred to as a second frame section.

The base station apparatus 1101 transmits a physical layer frame including the first frame section by using the first radio resource, and transmits a physical layer frame including the second frame section by using the second radio resource, achieving reduction of a DL-MU frame. It is preferable that, in order to adequately receive physical layer frames including the first frame section and the second frame section, the terminal apparatus 2101 have all or some of the information about the first radio resource, the information about the second radio resource, the information about the first frame section, and the information about the second frame section. That is, the base station apparatus 1101 may transmit, to the terminal apparatus 2101, all or some of the information about the first radio resource, the information about the second radio resource, the information about the first frame section, and the information about the second frame section.

As illustrated in FIG. 7, the base station apparatus 1101 may set a waiting time (for example, an SIFS, a PIFS, an RIFS, a DIFS, an AIFS, or another waiting time) between the PPDU 451 and the PPDU 455 and between the PPDU 452 and the PPDU 455, or may continuously transmit the PPDU 451 and the PPDU 455, and the PPDU 452 and the PPDU 455 without a waiting time.

As described above, it is preferable that the terminal apparatuses 2100 have information about allocation of radio resources (for example, the information about the first radio resource and the information about the second radio resource), and information about adjustment of frame lengths performed by the frame-length adjusting unit 11013b (for example, the information about the first frame section and the information about the second frame section). The base station apparatus 1101 may generate the information about adjustment of frame lengths. The base station apparatus 1101 generates information about allocation of the radio resources of the PPDUs 430 or the PPDUs 450 on the basis of the PPDUs 430 or the PPDUs 450 generated by the frame-length adjusting unit 11013b. Preferably, the base station apparatus 1101 notifies the terminal apparatuses 2100 of the first resource allocation information. The first resource allocation information may include all or part of the information about allocation of the radio resources and the information about adjustment of frame lengths.

The base station apparatus 1101 may also generate two or more pieces of information about a frame section. The frame-length adjusting unit 11013b may also define a DL-MU frame length by using the two or more pieces of information about a frame section.

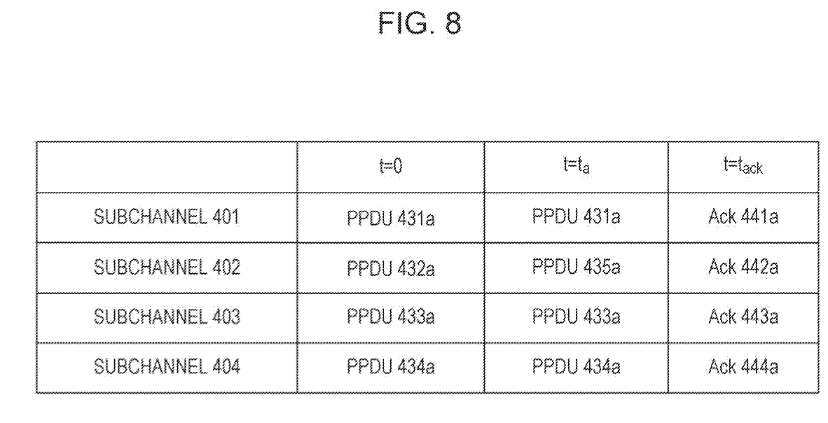

FIG. 8 is a diagram illustrating exemplary first resource allocation information in the example in FIG. 6. In FIG. 8, PPDUs 431a to 435a (hereinafter also referred to as “PPDUs 430a”) are information elements including information about destination terminal apparatuses for the PPDUs 431 to 435. Acks 441a to 444a (hereinafter also referred to as “Acks 440a”) are information about terminal apparatuses transmitting Acks 441 to 444. For example, each of the PPDUs 430a and the Acks 440a may be a MAC address of a corresponding terminal apparatus or a GIG. Other than this, as information about a terminal apparatus, an AID (Association Identifier), a PAID (Partial AID), or the like is used. An AID is an identifier that is independently set for a connecting terminal apparatus by a base station apparatus, and has a length of 16 bit. A PAID is a reduced identifier of 9 bit obtained by performing a determined hash function on an AID. The information about a terminal apparatus may be an identifier other than the above-described examples.

In the example in FIG. 8, t represents time, and a time of t=0 corresponds to the start time of a DL-MU transmission. A time of t=tₐ corresponds to a time at which the base station apparatus 1101 start transmission of the PPDU 435. Information at a time of t=tₐ is information (for example, the information about the first frame section, the information about the second frame section) about a time at which the base station apparatus 1101 changes, in the DL-MU transmission period, the destination of a transmission PPDU (in the example in FIG. 8, in the subchannel 402, information about a destination terminal apparatus is changed from the PPDU 432a to the PPDU 435a).

A time of t=t_{ack} and the Acks 440a may be explicitly notified, or may be implicitly notified. For example, a terminal apparatus 2100 may regard a time of t=t_{ack} as a time at which the terminal apparatus 2100 completes reception of PPDUs addressed to the terminal apparatus 2100. In this case, a terminal apparatus 2100 corresponding to the PPDU 432a may erroneously set a time of t=t_{ack}. For example, even after a terminal apparatus 2100 has received a PPDU addressed to the terminal apparatus 2100, when the terminal apparatus 2100 continues to receive a signal having a high received power level, a time at which reception of the signal having a high received power level is completed may be set as a time of t=t_{ack}. For example, the base station apparatus 1101 may insert information about a DL-MU transmission period in the MAC headers in the PPDUs 430.

Information about the Acks 440a transmitted by the terminal apparatuses 2100 may be explicitly notified to the terminal apparatuses 2100 by the base station apparatus 1101, or may be implicitly notified. It may be understood that, as an exemplary method of implicit notification, for example, a PPDU 430a at a time of t=0 and the corresponding Ack 440a indicate the same terminal apparatus 2100. That is, each of the terminal apparatuses 2100 may transmit an Ack by using a subchannel in which any of the PPDUs 430 is received at a time of t=0.

In the example in FIG. 6, a period between the PPDU 432 and the PPDU 435 may be provided or may not be provided.

In the example in FIG. 7, the PPDU 451 has a band width different from that of the PPDU 455. Therefore, in the example in FIG. 7, it is preferable that the first resource allocation information include the information about the first radio resource and the information about the second radio resource.

As described above, the base station apparatus 1101 notifies the terminal apparatuses 2100 of the first resource allocation information. However, the first resource allocation information may not include all of the information elements illustrated in FIG. 8. The terminal apparatuses 2100 may implicitly obtain some of the first resource allocation information elements.

The base station apparatus 1101 may include the first resource allocation information in information elements of a beacon, a probe response, an authentication response, and an association response, or may include the first resource allocation information in the physical layer header, the MAC header, or an MSDU in a transmission frame. The base station apparatus 1101 may divide the first resource allocation information for transmission.

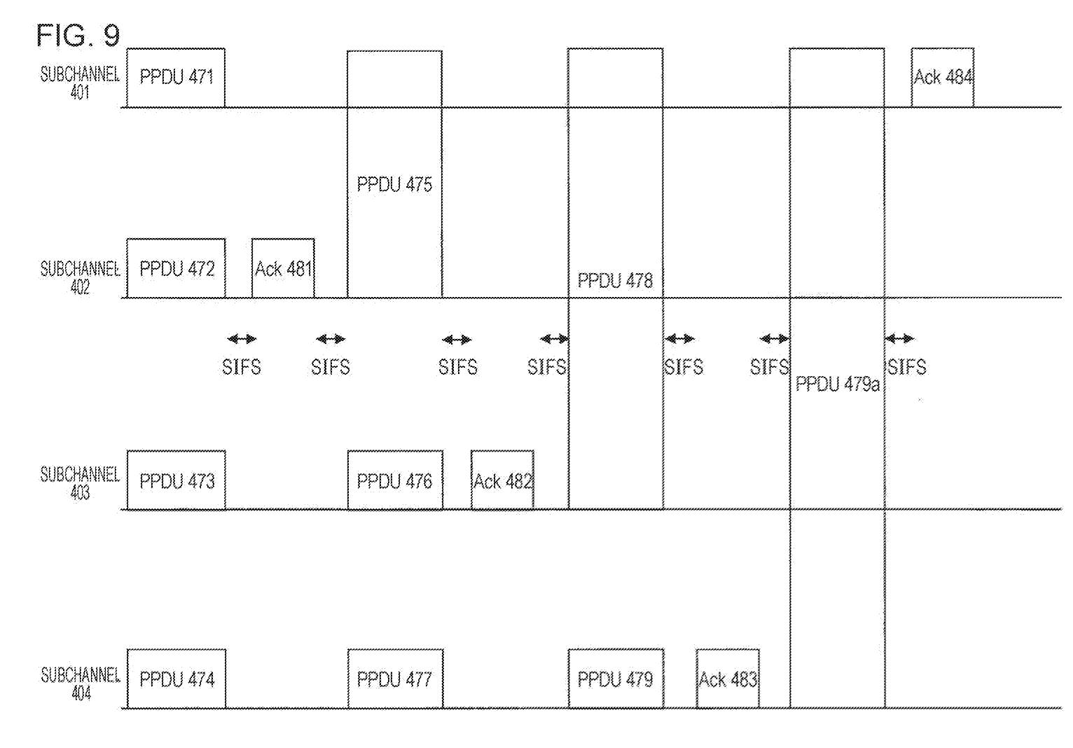

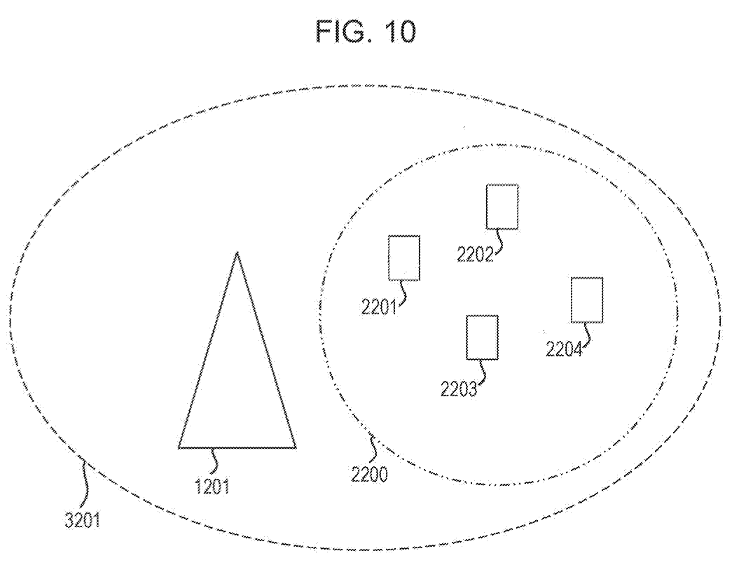

FIG. 9 is a diagram illustrating exemplary DL-MU transmission per when the frame-length adjusting unit 11013b operates. The frame-length adjusting unit generates PPDUs 471 to 479 and a PPDU 479a (hereinafter also referred to as “PPDUs 470” collectively). For example, the base station apparatus 1101 may generate the PPDU 471, the PPDU 473, and the PPDU 474 in accordance with the shortest PPDU 472. After the generated PPDUs 471 to 474 are transmitted by using the respective subchannels 400, the terminal apparatuses 2100 wait for a certain time so as not to perform transmission. Then, each of the terminal apparatuses 2100 transmits a corresponding one of Acks 481 to 484 (hereinafter also referred to as “Acks 480” collectively).

In the example in FIG. 9, a terminal apparatus 2100 that has received the PPDU 472 in the subchannel 402 transmits the Ack 481 in the subchannel 402. The terminal apparatuses 2100 that have received the PPDU 471, the PPDU 473, and the PPDU 474 in the subchannel 401, the subchannel 403, and the subchannel 404 are capable of determining that PPDUs 470 addressed to the terminal apparatuses 2100 remain in the DL-MU transmission period, and not transmitting Acks. The terminal apparatuses 2100 are also capable of multiplexing the other Acks on the Ack 481 by using UL-MU transmission.

Subsequently, after the base station apparatus 1101 successfully receives the Ack 481, the base station apparatus 1101 waits for a certain period (for example, an SIFS period). Then the base station apparatus 1101 may transmit PPDUs 475 to 477. In the DCF mode, typically, in the case where a wireless LAN apparatus having received an Ack wants to transmit the next PPDU, after the wireless LAN apparatus waits for a DIFS or AIFS period, the wireless LAN apparatus has to make a transition to backoff. In the example in FIG. 9, after the base station apparatus 1101 receives the Ack 481, the base station apparatus 1101 waits for an SIFS period. Then the base station apparatus 1101 transmits the PPDUs 475 to 477. Thus, reduction of a DL-MU transmission period is expected.

In the example in FIG. 9, after the base station apparatus 1101 receives the Ack 481, the base station apparatus 1101 uses the available subchannel 402 to transmit the PPDU 475 obtained through aggregation of the subchannels 401 to 402. The base station apparatus 1101 generates the PPDU 475 obtained through aggregation of the subchannels 401 to 402. Thus, improvement in frequency efficiency of the subchannel 402 is expected.

Subsequently, after a terminal apparatus 2100 having received the PPDU 476 waits for a certain time, the terminal apparatus 2100 transmits the Ack 482. After receiving the Ack 482, the base station apparatus 1101 waits for a certain time. Then, the base station apparatus 1101 transmits the PPDU 478 and the PPDU 479. The PPDU 478 is a PPDU obtained through aggregation of the subchannels 401 to 403.

In the example in FIG. 9, after a terminal apparatus 2100 having received she PPDU 479 waits for a certain time, the terminal apparatus 2100 transmits the Ack 483. After receiving the Ack 483, the base station apparatus 1101 waits for a certain time, and then transmits the PPDU 479a. The PPDU 479a is a PPDU obtained through aggregation of the subchannels 400.

Finally, after a terminal apparatus 2100 having received the PPDU 479a waits for a certain time, the terminal apparatus 2100 transmits the Ack 484.

In the example in FIG. 9, the terminal apparatuses 2100 do not aggregate some or all of the subchannels 400, and transmit the Acks 480 only by using a single subchannel. The terminal apparatuses 2100 may transmit the Acks 480 obtained through aggregation of some or all of the subchannels 400. The terminal apparatuses 2100 may notify the base station apparatus 1101 of function information about whether or not the terminal apparatuses 2100 have a function of receiving a DL-MU frame generated by the frame-length adjusting unit 11013b.

As described above, the base station apparatus 1101 adjusts frame lengths in DL-MU transmission, achieving reduction of a DL-MU transmission period. Thus, frequency efficiency of the wireless communication system may be improved.

### Second Embodiment

FIG. 10 is a diagram illustrating an exemplary management range 3201 of a wireless communication system according to the present embodiment. The management range 3201 includes a base station apparatus 1201 and terminal apparatuses 2201 to 2204. In the example in FIG. 10, the management range 3201 includes four terminal apparatuses. However, the method according to the present embodiment may be implemented as long as the management range 3201 includes two or more terminal apparatuses 2100. Hereinafter, the terminal apparatuses 2201 to 2204 are referred to as terminal apparatuses 2100.

The wireless communication system according to the present embodiment may perform UL-MU transmission. That is, the base station apparatus 1201 may receive a frame (UL-MU frame) that is obtained through multiplexing in a radio resource in UL transmission and that is transmitted by multiple terminal apparatuses 2200.

A description will be made below under the assumption that the management range 3201 performs UL-OFDMA. However, the method of the present invention is not limited to UL-OFDMA.

In UL-MU transmission, the base station apparatus 1201 may notify the multiple terminal apparatuses 2200 of a timing of start of UL-MU transmission. The notification of a timing of start of UL-MU transmission enables the multiple terminal apparatuses 2200 to perform transmission at the same time. However, the terminal apparatuses 2200 may be provided with different respective pieces of hardware. Therefore, a transmission time may be varied due to deviation of clock timing or the like. In order that the base station apparatus 1201 determines a timing of start of UL-MU transmission, the base station apparatus 1201 needs to grasp the number of transmission frames (or a payload, a data amount, and the like) contained in the multiple terminal apparatuses 2200. A method in which the base station apparatus 1201 grasps the number of transmission frames contained by the multiple terminal apparatuses 2200 will be described below.

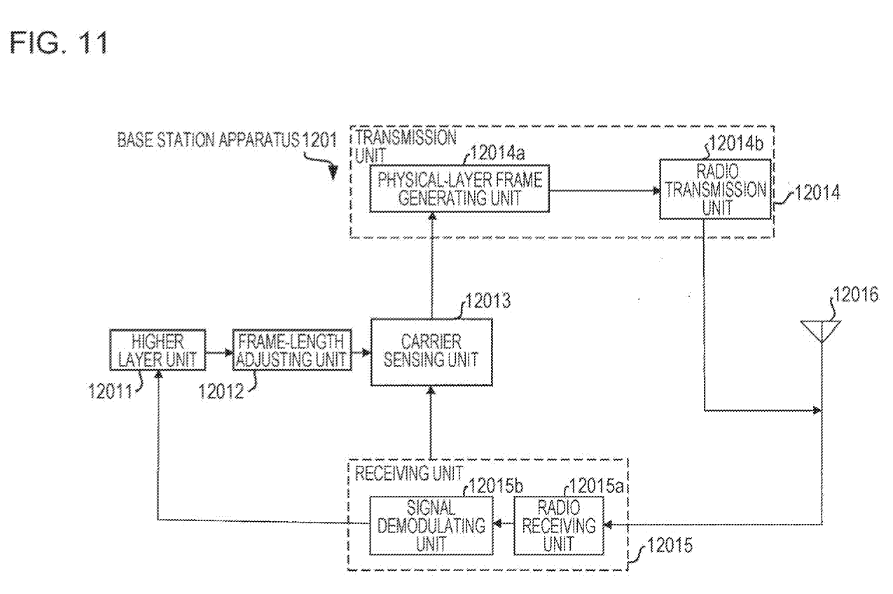

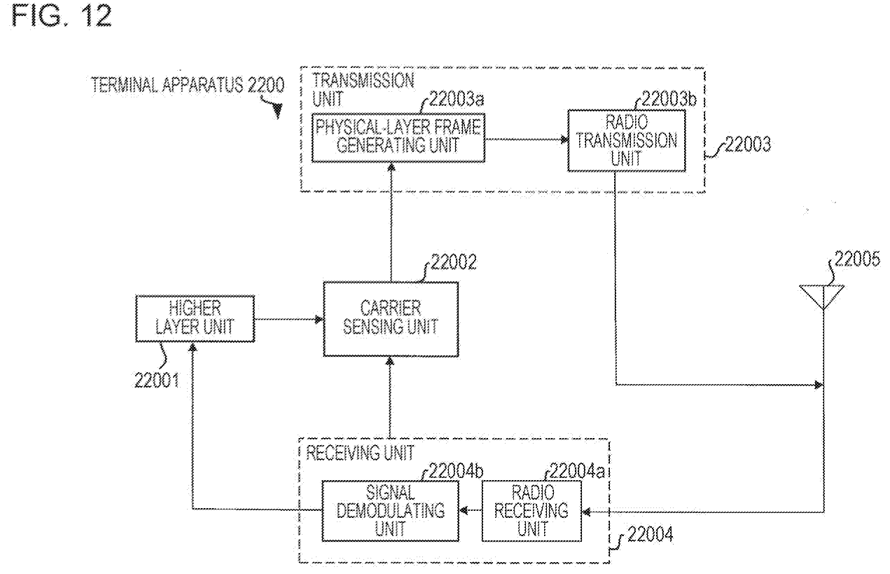

FIG. 11 is a diagram illustrating an exemplary apparatus configuration of the base station apparatus 1201. The base station apparatus 1201 has a configuration including a higher layer unit 12011, a frame-length adjusting unit 12012, a carrier sensing unit 12013, a transmission unit 12014, a receiving unit 12015, and an antenna unit 12016. The higher layer unit 12011 is connected to other networks, and has a function of notifying the carrier sensing unit 11012 of information associated with a transmission frame.

The frame-length adjusting unit 12012 has a function of determining the structure of a UL-MU frame suitable for UL-MU transmission. The frame-length adjusting unit 12012 generates first resource allocation information including information about the structure of a UL-MU frame. A method of determining the structure of a UL-MU frame will be described.

The frame-length adjusting unit 12012 may have a function of generating a transmission frame for notifying the terminal apparatuses 2200 of a timing of start of UL-MU transmission. Hereinafter, a transmission frame for notifying the terminal apparatuses 2200 of a timing of start of UL-MU transmission is referred to as a timing frame or UL-MU Poll. The timing frame may include information associated with a UL-MU transmission time, or the base station apparatus 1201 and the multiple terminal apparatuses 2200 may agree that, after receiving a timing frame, the multiple terminal apparatuses wait for a certain time, and then UL-MU transmission is started. In the latter case, a format similar to the format of a control frame or a management frame which is defined in the IEEE 802.11 standard may be used for the timing frame.

The carrier sensing unit 12013 has a function of making a determination about whether transmission is to be performed, on the basis of carrier sense. In the present embodiment, the carrier sensing unit 12013 may perform carrier sensing on multiple channels.

The transmission unit 12014 includes a physical-layer frame generating unit 12014a and a radio transmission unit 12014b.

The physical-layer frame generating unit 12014a has a function of generating a physical layer frame from a transmission frame transmitted from the carrier sensing unit 12013. The physical-layer frame generating unit 12014a performs error correction coding, modulation, precoding-filter multiplication, and the like on a transmission frame. The physical-layer frame generating unit 12014a notifies the radio transmission unit 12014b of the generated physical layer frame.

The radio transmission unit 12014b converts the UL-MU frame generated by the physical-layer frame generating unit 12014a into a signal in a radio frequency (RF: Radio Frequency) band, and generates a radio frequency signal. The processes performed by the radio transmission unit 12014b include digital-analog conversion, filtering, and frequency conversion from a base band to an RF band.

The receiving unit 12015 includes a radio receiving unit 12015a and a signal demodulating unit 12015b. The receiving unit 12015 has a function of calculating a received power level from an RF band signal received by the antenna unit 12016. However, the method of calculating a received power level is not limiting. The receiving unit 12015 notifies the carrier sensing unit 12013 of information about the calculated received power level. The carrier sensing unit 12013 may make a determination about whether transmission is to be performed, on the basis of the information about a received power level which is transmitted by the receiving unit 12015.

The radio receiving unit 12015a has a function of converting an RF band signal received by the antenna unit 12016 into a base band signal and generating a physical layer signal (for example, a physical layer frame). The processes performed by the radio receiving unit 12015a include a frequency conversion process from an RF band to a base band, filtering, and analog-digital conversion.

The signal demodulating unit 12015b has a function of demodulating the physical layer signal generated by the radio receiving unit 12015a. The processes performed by the signal demodulating unit 12015b include channel equalization, de-mapping, and error correction decoding. The signal demodulating unit 12015b may extract, for example, information included in the physical layer header, information included in the MAC header, and information included in the transmission frame, from the physical layer signal. The signal demodulating unit 12015b may notify the higher layer unit 12011 of the extracted information. The signal demodulating unit 12015b may extract one or some of the information included in the physical layer header, the information included in the MAC header, and the information included in the transmission frame.

The antenna unit 12016 has a function of transmitting a radio frequency signal generated by the radio transmission unit 12014b, through a wireless space to the terminal apparatuses 2200. The antenna unit 12016 also has a function of receiving radio frequency signals transmitted from the terminal apparatuses 2200. When the base station apparatus 1201 performs carrier sensing, the antenna unit 12016 also has a function of receiving a signal in the channel in the wireless space.

FIG. 12 is a diagram illustrating an exemplary apparatus configuration of a terminal apparatus 2200. The terminal apparatus 2200 includes a higher layer unit 22001, a carrier sensing unit 22002, a transmission unit 22003, a receiving unit 22004, and an antenna unit 22005.

The higher layer unit 22001 is connected to other networks, and has a function of notifying the carrier sensing unit 22002 of information about a transmission frame.

The carrier sensing unit 22002 has a function of making a determination about whether transmission is to be performed, on the basis of carrier sense.

The transmission unit 22003 includes a physical-layer frame generating unit 22003a and a radio transmission unit 22003b.

The physical-layer frame generating unit 22003a has a function of generating a physical layer frame from a transmission frame transmitted from the carrier sensing unit 22002. The physical-layer frame generating unit 22003a performs error correction coding, modulation, precoding-filter multiplication, and the like on a transmission frame. The physical-layer frame generating unit 22003a notifies the radio transmission unit 22003b of the generated physical layer frame. The physical-layer frame generating unit 22003a may construct a physical layer frame on the basis of the first resource allocation information transmitted from the base station apparatus 1201. Operations performed by the physical-layer frame generating unit 22003a will be described in detail below.

The radio transmission unit 22003b converts the physical layer frame generated by the physical-layer frame generating unit 22003a into a signal in a radio frequency (RF: Radio Frequency) band, and generates a radio frequency signal. The processes performed by the radio transmission unit 22003b include digital-analog conversion, filtering, and frequency conversion from a base band to an RF band.

The receiving unit 22004 includes a radio receiving unit 22004a and a signal demodulating unit 22004b. The receiving unit 22004 has a function of calculating a received power level from an RF band signal received by the antenna unit 22005. However, the method of calculating a received power level is not limiting. The receiving unit 22004 notifies the carrier sensing unit 22002 of information about the calculated received power level. The carrier sensing unit 22002 may make a determination about whether transmission is to be performed, on the basis of the information about a received power level which is transmitted by the receiving unit 22004.

The radio receiving unit 22004a has a function of converting an RF band signal received by the antenna unit 22005 into a base band signal and generating a physical layer signal (for example, a physical layer frame or an MU frame). The processes performed by the radio receiving unit 22004a include a frequency conversion process from an RF band to a base band, filtering, and analog-digital conversion.

The signal demodulating unit 22004b has a function of demodulating the physical layer signal generated by the radio receiving unit 22004a. The processes performed by the signal demodulating unit 22004b include channel equalization, de-mapping, and error correction decoding. The signal demodulating unit 22004b may extract, for example, information included in the physical layer header, information included in the MAC header, and information included in the transmission frame from the physical layer signal. The signal demodulating unit 22004b may notify the higher layer unit 22001 of the extracted information. The signal demodulating unit 22004b may extract one or some of the information included in the physical layer header, the information included in the MAC header, and the information included in the transmission frame.

The antenna unit 22005 has a function of transmitting a radio frequency signal generated by the radio transmission unit 22003b through a wireless space to the base station apparatus 1201. The antenna unit 22005 also has a function of receiving a radio frequency signal transmitted from the base station apparatus 1201. When the terminal apparatus 2200 performs carrier sensing, the antenna unit 22005 also has a function of receiving a signal in the channel in the wireless space.

Subchannels used in the wireless communication system according to the present embodiment are similar to the subchannels 400 according to the first embodiment, and will not be described.

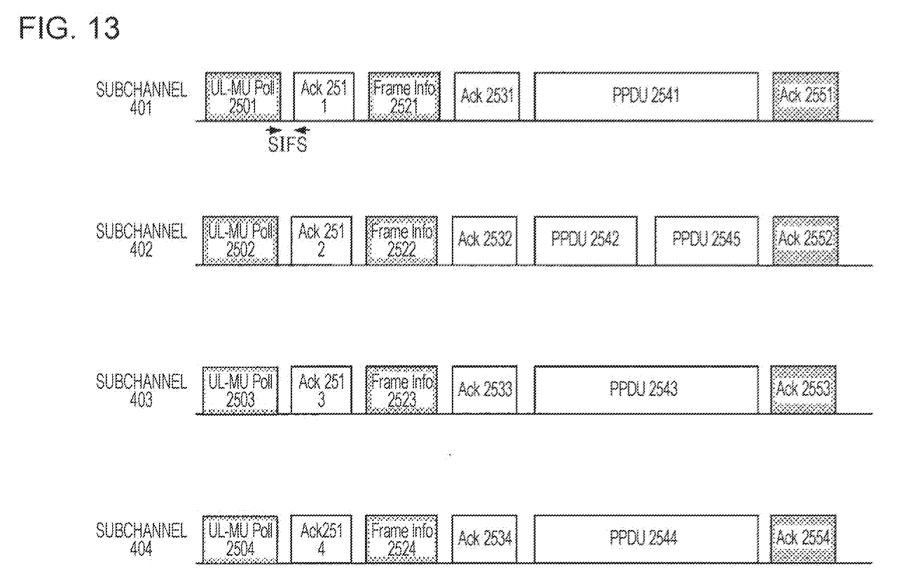

FIG. 13 is a diagram illustrating exemplary UL-MU transmission performed when the frame-length adjusting unit 12012 adjusts the lengths of UL-MU frames. A flow of UL-MU transmission will be described below on the basis of the example in FIG. 13. A shaded frame indicates a frame transmitted by the base station apparatus 1201. A method of adjusting frame lengths which is performed by the frame-length adjusting unit 12012 is not limited to the example in FIG. 13.

In the example in FIG. 13, the base station apparatus 1201 and the terminal apparatuses 2200 wait just for an SIFS so as not to perform transmission when the base station apparatus 1201 and the terminal apparatuses 2200 are to transmit frames. The base station apparatus 1201 and the terminal apparatuses 2200 according to the present embodiment may set an SIFS, a PIFS, an RIFS, a DIFS, an AIFS, or another waiting time as a transmission waiting time used in participation in UL-MU transmission, or do not necessarily set a waiting time (or may set the waiting time to 0).

UL-MU Polls 2500 and Frame Infos 2520 may include information for notifying the terminal apparatuses 2200 of radio resources used in transmission of control frames and management frames in UL-MU transmission. The example in FIG. 13 is described under the assumption that the terminal apparatuses 2200 transmit Acks 2520 and Acks 2530 in a multiplexing manner in frequency resource. However, Acks 2510 and the Acks 2520 may be multiplexed in time resource.

The base station apparatus 1201 obtains information about payloads of the multiple terminal apparatuses 2200, and determines whether or not UL-MU transmission is to be performed. The base station apparatus 1201 having determined that UL-MU transmission is to be performed transmits UL-MU Polls 2501 to 2504 (hereinafter also referred to as the “UL-MU Polls 2500”) to the multiple terminal apparatuses 2200. The UL-MU Polls 2500 are frames that enable the base station apparatus 1201 to notify the terminal apparatuses 2200 of start of a UL-MU transmission period. The UL-MU Polls 2500 may be skipped. When the base station apparatus 1201 skips the UL-MU Polls 2500, the base station apparatus 1201 may notify the terminal apparatuses 2200 of start of a UL-MU transmission period by using Frame Infos 2521 to 2524 (hereinafter also referred to as the “Frame Infos 2520”).

The terminal apparatuses 2200 having received the UL-MU Polls 2500 notify the base station apparatus 1201 of an Ack 2511.

Subsequently, the base station apparatus 1201 notifies the terminal apparatuses 2200 of the Frame Infos 2520. The Frame Infos 2500 may include the first resource allocation information generated by the frame-length adjusting unit 12012. The first resource allocation information may include information about generation of physical layer frames, such as a modulating method, a coding method, and a precoding filter generating method which are used by the terminal apparatuses 2200.

The terminal apparatuses 2200 having received the Frame Infos 2520 notify the base station apparatus 1201 of Acks 2531 to 2534 (hereinafter also referred to as “Acks 2530”). The terminal apparatuses 2200 may skip the Acks 2530. When the terminal apparatuses 2200 skip the Acks 2530, the terminal apparatuses 2200 transmit PPDUs 2541 to 2545 (hereinafter also referred to as “PPDUs 2540”) to the base station apparatus 1201.

The terminal apparatuses 2200 generate the PPDUs 2540 on the basis of the first resource allocation information transmitted from the base station apparatus 1201. When the first resource information includes information about generation of physical layer frames in addition to information about frame lengths and information about resources to be used, the physical-layer frame generating unit 22003a generates the PPDUs 2540 according to the first resource allocation information. The terminal apparatuses 2200 start transmission of the PPDUs 2540 on the basis of a timing of start of UL-MU transmission which is transmitted by the base station apparatus 1201.

The terminal apparatuses 2200 having received the PPDUs 2540 notify the multiple terminal apparatuses of Acks 2551 to 2554 (hereinafter also referred to as “Acks 2550”), and ends the UL-MU transmission.

The example in FIG. 13 is described under the assumption that the base station apparatus 1201 uses DL-MU transmission to transmit the UL-MU Polls 2500, the Frame Infos 2520, and the Acks 2550. However, the base station apparatus 1201 does not necessarily perform DL-MU transmission. For example, the base station apparatus 1201 may temporally divide the UP-MU Polls 2500, the Frame Infos 2520, and the Acks 2550 for transmission, or may use multicasting (transmission means for notifying multiple terminal apparatuses of the same information). The terminal apparatuses 2200 may notify the base station apparatus 1201 of function information about whether or not the terminal apparatuses 2200 have a function of generating a physical layer frame, for example, according to the first resource allocation information.

As described above, the terminal apparatuses 2200 adjust frame lengths in UL-MU transmission, achieving reduction of a UL-MU transmission period. Thus, frequency efficiency of the wireless communication system may be improved.

In addition to the embodiments described above, the following aspects may be employed.

(A) A base station apparatus of the present invention is applied to a communication system that controls transmission occasions in an autonomous and distributed manner, and communicates with a terminal apparatus. The base station apparatus includes a physical-layer frame generating unit and a radio unit. The physical-layer frame generating unit generates a physical layer frame which is addressed to the terminal apparatus and which includes a first frame section transmitted in a first radio resource and a second frame section transmitted in a second radio resource. The radio unit transmits the physical layer frame.

(B) The base station apparatus of the present invention is characterized by signaling information about a function of generating the physical layer frame including the first frame section and the second frame section, to the terminal apparatus.

(C) The base station apparatus of the present invention is characterized in that the physical-frame generating unit multiplexes a different physical layer frame on the physical layer frame. The different physical layer frame is addressed to a test apparatus different from the terminal apparatus.

(D) The base station apparatus of the present invention is characterized by including a frame-length adjusting unit that determines the lengths of the first frame section and the second frame section on the basis of the frame length of a physical layer frame addressed to a terminal apparatus different from the terminal apparatus.

(E) The base station apparatus of the present invention is characterized by signaling, to the terminal apparatus, information indicating the first frame section and the second frame section.

(F) The base station apparatus of the present invention characterized by signaling, to the terminal apparatus, information indicating that a function of generating the physical layer frame including the first frame section and the second frame section is not included.

(G) A terminal apparatus of the present invention is applied to a communication system that controls transmission occasions in an autonomous and distributed manner, and communicates with a base station apparatus. The terminal apparatus includes a receiving unit that receives a first frame section on the basis of information indicating the first frame section which is signaled by the base station apparatus.

(H) The terminal apparatus of the present invention is characterized in that the receiving unit receives the first frame section and a second frame section on the basis of information about a function of generating a physical layer frame including the second frame section, in addition to information about a function of generating a physical layer frame including the first frame section.

As described above, according to the present embodiments, efficient use of radio resources and reduction of the transmission time of transmission frames may be achieved.

Programs operated in the base station apparatus and the terminal apparatuses according to the present invention are programs (programs causing a computer to operate) controlling a CPU and the like so that the functions of the above-described embodiments of the present invention are implemented. Information handled in these apparatuses is temporarily stored in a RAM when the information is to be processed. After that, the information is stored in various ROMs and HDDs, and is read by the CPU when necessary for modification and writing. A recording medium storing the programs may be any of a semiconductor medium (for example, a ROM or a nonvolatile memory card), an optical recording medium (for example, a DVD, an MO, an MD, a CD, or a BD), a magnetic recording medium (for example, a magnetic tape or a flexible disk), or the like. By executing the programs having been loaded, not only are the functions of the above-described embodiments implemented, but also processing may be performed in collaboration with an operating system, other application programs, or the like on the basis of instructions of the programs, achieving the functions of the present invention.

When the programs are to be distributed in a market, the programs may be distributed by storing the programs in a portable recording medium, or may be transferred to a server computer connected over a network such as the Internet. In this case, a storage device of the server computer is also encompassed in the present invention. Some or all of the terminal apparatuses and the base station apparatus according to the above-described embodiments may be implemented typically as LSIs that are integrated circuits. The functional blocks of a receiving apparatus may be made into individual chips, or some or all of the functional blocks may be integrated into one chip. When the functional blocks are made into integrated circuits, an integrated-circuit controller for controlling these is added.

Ways of fabricating an integrated circuit are not limited to an LSI. A dedicated circuit or a general-purpose processor may be used in the implementation. In addition, when a technique of fabricating an integrated circuit replaced by an LSI emerges with advance of the semiconductor technique, the integrated circuit produced in the technique may be used.

The invention of the subject application is not limited to the above-described embodiments. A terminal apparatus provided by the invention of the subject application is not limited to application to a mobile station apparatus. It goes without saying that the invention may be applied to fixed or non-moving electronic equipment that is installed indoors or outdoors, such as an AV apparatus, a kitchen apparatus, a cleaning/washing machine, an air conditioner, office equipment, a vending machine, other living appliances, and the like.

The embodiments of the present invention are described in detail with reference to the drawings. The specific configuration is not limited to the embodiments. A design or the like in a scope without departing from the gist of the invention is also encompassed in the claims.

This international application claims the priority of Japanese Patent Application No. 2015-040590, filed Mar. 2, 2015, which is hereby incorporated by reference herein in the entirety of Japanese Patent Application No. 2015-040590.

### REFERENCE SIGNS LIST

401-404 subchannel

1101 base station apparatus

1201 base station apparatus

2100 terminal apparatus

2101-2104 terminal apparatus

2200 terminal apparatus

2201-2204 terminal apparatus

3101 management range

3201 management range

11011 higher layer unit

11012 carrier sensing unit

11013 transmission unit

11013a physical-layer frame generating unit

11013b frame-length adjusting unit

11013c radio transmission unit

11014 receiving unit

11014a radio receiving unit

11014b signal demodulating unit

11015 antenna unit

12011 higher layer unit

12012 frame-length adjusting unit

12013 carrier sensing unit

12014 transmission unit

12014a physical-layer frame generating snit

12014h radio transmission unit

12015 receiving unit

12015a radio receiving unit

12015b signal demodulating unit

12016 antenna unit

21001 higher layer unit

21002 carrier sensing unit

21003 transmission unit

21003a physical-layer frame generating unit

21003b radio transmission unit

21004 receiving unit

21004a radio receiving unit

21004b signal demodulating unit

21005 antenna unit

22001 higher layer unit

22002 carrier sensing unit

22003 transmission unit

22003a physical-layer frame generating unit

22003b radio transmission unit

22004 receiving unit

22004a radio receiving unit

22004b signal demodulating snit

22005 antenna unit

1. A base station apparatus transmitting a transmission frame to a terminal apparatus by using at least one of radio resources, the base station apparatus comprising:
a physical-layer frame generating unit that divides a transmission frame addressed to the terminal apparatus into a plurality of transmission frames, and that generates physical layer frames in such a manner that the transmission frames obtained through division are transmitted in a plurality of radio resources; and
a radio transmission unit that transmits the generated physical layer frames to the terminal apparatus in the plurality of radio resources.

2. The base station apparatus according to claim 1,
wherein the physical-layer frame generating unit generates the physical layer frames in such a manner that, among the transmission frames that are obtained through division and that are addressed to the terminal apparatus, a first transmission frame is transmitted in a first radio resource and a second transmission frame is transmitted in a second radio resource.

3. The base station apparatus according to claim 1,
wherein the terminal apparatus is notified of function information indicating a function the physical layer frames.

4. The base station apparatus according to claim 1,
wherein the physical-layer frame generating unit multiplexes the physical layer frames on a transmission frame addressed to a terminal apparatus different from the terminal apparatus.

5. (canceled)

6. The base station apparatus according to claim 1,
wherein the radio transmission unit collectively transmits radio resource information about the plurality of radio resources to the terminal apparatus by using one of the plurality of radio resources.

7. A terminal apparatus receiving a transmission frame transmitted from a base station apparatus by using at least one of a plurality of radio resources, the terminal apparatus comprising:
a receiving unit that receives a plurality of transmission frames and function information of physical layer frames, the plurality of transmission frames being transmitted in radio resources, the function information indicating at least timings at which the respective transmission frames are transmitted and the radio resources in which the respective transmission frames are transmitted,
wherein the function information is used to determine the radio resources and the transmission timings for the received transmission frames.
